(19) United States
(12) Patent Application Publication
(10) Pub. No.: US 2026/0301382 A1
(43) Pub. Date: Oct. 1, 2026

(54) GENERATING TRAINING DATA FOR GENERATING IMAGES WITH LIGHTING MODIFICATIONS

(71) Applicant: Google LLC, Mountain View, CA (US)

(72) Inventors: Nadav Magar, Tel-Aviv (IL); Amir Hertz, New York, NY (US); Eric Tabellion, Belmont, CA (US); Alexander Rav Acha, Rehovot (IL); Ariel Shamir, Mevaseret Zion (IL); Yedid Hoshen, Jerusalem (IL)

(21) Appl. No.: 19/569,894

(22) Filed: Mar. 17, 2026

Related U.S. Application Data
(60) Provisional application No. 63/777,604, filed on Mar. 25, 2025.

(51) Int. Cl. G06V 10/774; G06T 11/60

(52) U.S. Cl. CPC G06V 10/774; G06T 11/60

(57) ABSTRACT

Methods, systems, and apparatus, including computer programs encoded on computer storage media, for obtaining a plurality of training examples, each training example comprising a respective first image depicting a corresponding scene when a target light source is in a first state and a respective second image depicting the corresponding scene when the target light source is in a second state; generating, for each training example, a plurality of respective modified images that each depict the corresponding scene when the target light source is in a respective modified state; and generating an augmented set of training data for training an image generation model, wherein the augmented set of training data comprises a plurality of additional training examples, each additional training example corresponding to one of the training examples and comprising two images selected from the plurality of respective modified images generated for the corresponding training example.

### CROSS-REFERENCE TO RELATED APPLICATIONS

This application claims priority to U.S. Provisional Application No. 63/777,604, filed on Mar. 25, 2025. The disclosure of the prior application is considered part of and is incorporated by reference in its entirety in the disclosure of this application

### BACKGROUND

This specification relates to generating images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that augments training data for training an image generation model to generate images with lighting modifications.

Particular embodiments of the subject matter described in this specification can be implemented so as to realize one or more of the following advantages.

Training machine learning models to perform tasks such a relighting task requires a large set of training data. Obtaining a large amount of training data for these tasks, e.g., where each training sample includes two images depicting the same scene with different lighting, can be difficult. In particular, obtaining diverse images that represent complex illumination changes can be difficult. Unlike conventional approaches, the system described in this specification can effectively augment a dataset that includes images depicting a range of lighting modifications. For example, the system can augment an existing set of training data that may be insufficient (e.g., in size or diversity). The system can obtain existing training examples from the existing set of training data that each include a first image and a second image that depict the same scene with a target light source in a different state. The system can generate, for each existing training example, multiple modified images that each depict the same scene with the target light source in a respective modified state. The system can generate additional training examples that each include images selected from the respective modified images. Once generated, images can be sampled from the dataset to augment a dataset with additional training examples for training an image generation model. Training the image generation model on a larger number and greater variation of training examples allows the image generation model to generalize better to previously unseen inputs at inference. The system described in this specification can train an image generation model to perform relighting tasks. Some conventional systems require multiple input views of the scene at inference time, or do not provide explicit control over lighting modifications. An image generation model trained on augmented training examples as described in this specification can provide for fine-grained, parametric control of lighting modifications to a scene, e.g., properties of a target light source, properties of ambient light, or tone mapping effects. For example, the system can process an input image that depicts a scene and an input that specifies a lighting modification to be performed on the input image using the image generation model to generate an output image that depicts the scene according to the lighting modification. The input can specify, for example, a target light source depicted in the input image, a relative intensity change for a target light source, a light color for a target light source, a relative ambient light intensity change, or a tone mapping strategy.

In some implementations, the system can train an image generation model to perform a variety of relighting tasks. For example, the system can provide for inserting a new light source into an image, illuminating non light sources and non-photorealistic images, or creating animations of light changes using a static image. For example, the system can obtain data representing a new light source and an image depicting a scene. The system can generate a modified image that depicts the scene that includes the new light source, e.g., by processing at least the data representing the new light source and the image using the image generation model. As another example, the system can process at least an image and a segmentation mask for a non light source, e.g., an object that conventionally does not emit light, depicted in the image using the image generation model to generate an output image that depicts the non light source illuminated. As another example, the system can process at least a non-photorealistic image, e.g., a drawing, using the image generation model to illuminate the non-photorealistic image. As another example, the system can process at least an image depicting a scene using the image generation model to generate a sequence of images depicting the scene with lighting modifications. For example, the system can process at least the image to generate a modified image with a lighting modification, and process the modified image to generate a further modified image with another lighting modification, and so on. The image generation model can thus perform a larger variety of tasks as a result of training on augmented training examples as described in this specification, compared to training on an existing set of training data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for generating an augmented set of training data.

FIG. 2 is a flow diagram of an example process for generating an augmented set of training data.

FIG. 3 is a diagram of example processes for generating modified images.

FIG. 4 shows an example system for generating an image using an image generation model.

FIG. 5 is a flow diagram of an example process for generating an image using an image generation model.

FIG. 6 shows example images generated by image generation models.

Like reference numbers and designations in the various drawings indicate like elements.

### DETAILED DESCRIPTION

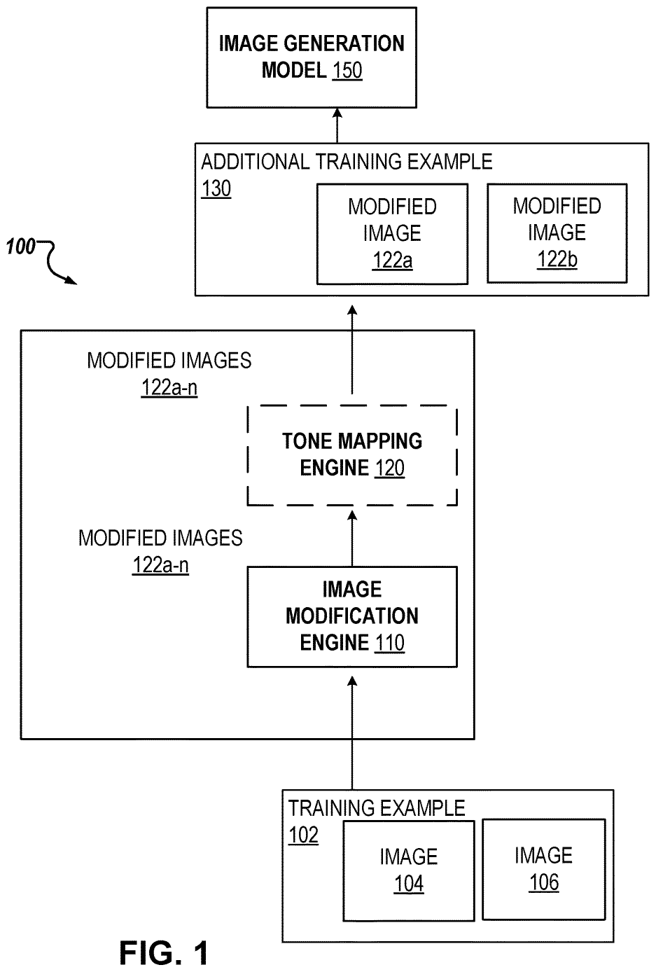

FIG. 1 shows an example system 100 for generating an augmented set of training data. The system 100 is an example of a system implemented as computer programs on one or more computers in one or more locations in which the systems, components, and techniques described below are implemented.

The system 100 augments a set of training data for training an image generation model 150 to generate images with lighting modifications.

The lighting modifications can include, for example, a lighting modification for a light source depicted in an image, e.g., as a physical object, e.g., light fixture, represented by pixels in the image, or as a spatial location within the scene. The light source can include an object. As a particular example, the light source can include an artificial light source such as a lightbulb. As another example, the light source can include a natural light source such as a flame or a window. In some examples, the lighting modifications can include a modification of ambient light of a scene depicted in the image.

In some examples, the image generation model 150 may not perform well at inference after being trained on an initial set of training data, e.g., that includes a training example 102. For example, if the initial set of training data includes input training examples depicting one type of light, the image generation model 150 may not perform well on generating images depicting different types of light. In addition, if the initial set of training data does not include a sufficient number of input training examples, the image generation model 150 may not generalize well on previously unseen inputs.

To improve the performance of the image generation model 150, the system 100 augments an initial set of training data for training the image generation model 150. The augmented set of training data includes multiple training examples such as the additional training example 130. The augmented set of training data includes a larger number, variety, or both, of training examples than the initial set of training data. Training the image generation model 150 on the augmented set of training data results in better performance at inference. An augmented set of training data with a larger number of training examples allows the image generation model 150 to generalize better to previously unseen inputs at inference.

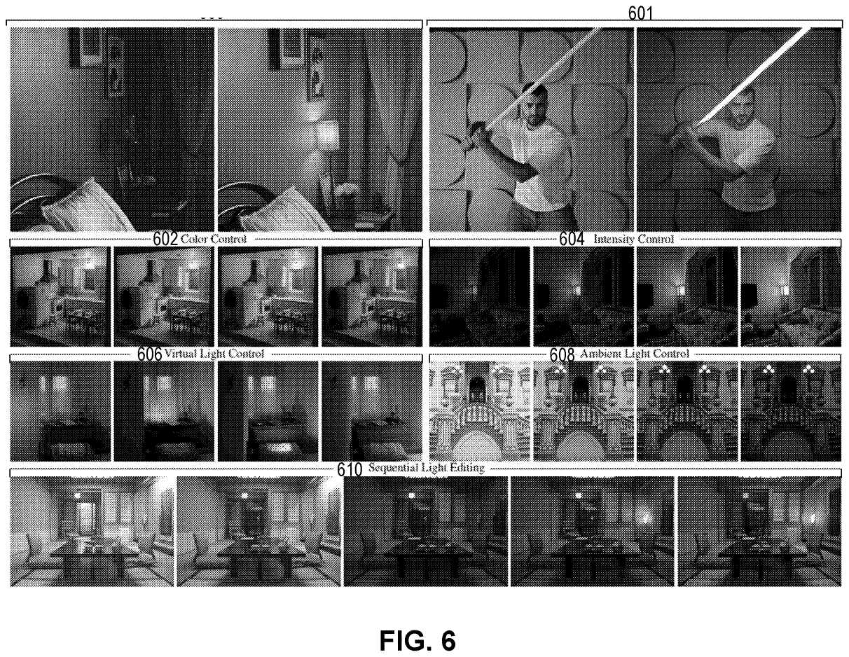

The image generation model 150 can be configured to process an input in accordance with current values of parameters of the image generation model 150 to generate an image. For example, the input can include one or more conditioning inputs, e.g., text, images, segmentation masks, etc. Example images generated by the image generation model 150 are described below with reference to FIG. 6.

The image generation model 150 can have any appropriate architecture for performing an image generation task. For example, the image generation model 150 can be a neural network that includes any appropriate types of neural network layers (e.g., embedding layers, fully connected layers, attention layers, and so forth) in any appropriate number (e.g., 2 layers, or 5 layers, or 10 layers) and connected in any appropriate configuration (e.g., as a directed graph of layers). As an example, the image generation model 150 can include a diffusion model or an autoregressive model. In some examples, the image generation model 150 can have a Transformer-based architecture. Some example image generation models are described in Dustin Podell et al., SDXL: Improving Latent Diffusion Models for High-Resolution Image Synthesis, arXiv:2307.01952 (2023) and Chitwan Saharia et al., Photorealistic Text-to-Image Diffusion Models with Deep Language Understanding, arXiv:2205.11487 (2022).

In some implementations, the image generation model 150 can be configured to perform different types of lighting modifications. For example, the image generation model can perform parametric control of properties of a target light source depicted in an image (e.g., intensity and color). Alternatively or in addition, the image generation model can perform generative removal of a light source, where the model is configured to remove the pixels of a physical object representing the light source and its effects, such as cast shadows and reflections, from the scene. Alternatively or in addition, the image generation model can perform generative insertion of a new light source. For example, the image generation model can receive data specifying an object to be added to the scene, and the image generation model can generate the added object along with its corresponding lighting effects, such as illumination, shadows, and reflections, that are applied to the rest of the scene. An example image generation model is described in further detail in Winter, D., et al., ObjectDrop: Bootstrapping Counterfactuals for Photorealistic Object Removal and Insertion, arXiv preprint arXiv:2403.18818 (2024).

To generate the training data, the system obtains multiple training examples such as the input training example 102. Each training example includes a respective first image 104 depicting a corresponding scene when a target light source is in a first state. The target light source in the first state can be described by one or more properties, for example, an intensity for the target light source, or a color for the target light source.

Each training example includes a respective second image 106 that depicts the corresponding scene when the target light source is in a second state. The target light source in the second state can be described by one or more properties, for example, an intensity for the target light source, or a color for the target light source. The target light source in the second state is different from the target light source in the first state. For example, for at least one of the properties, the target light source in the second state is different from the target light source in the first state.

The target light source is depicted in the first image 104 and the second image 106, e.g., as a physical object represented by pixels of the first image 104 and the second image 106, or as a spatial location within the scene depicted by the first image 104 and the second image 106.

Each of the images 104 and 106 includes pixels that each have one or more intensity values. In some examples, the images can be in a raw image format, e.g., includes raw sensor data. In some examples, the images can be in a linear RGB format.

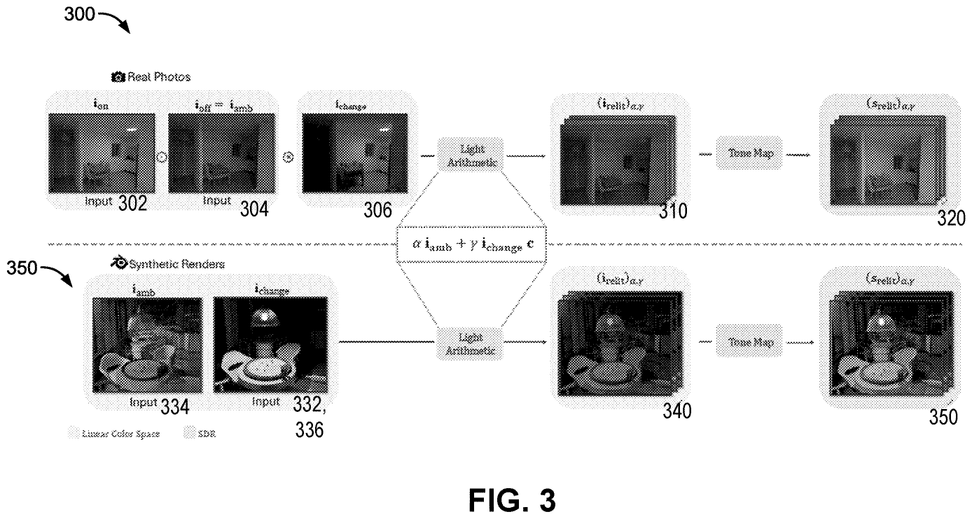

In some examples, each of the images 104 and 106 can be a real image, for example, of a real-world scene. In some examples, each of the images 104 and 106 can be a synthetic image, also referred to as a synthetically-generated image. For example, the synthetic image can depict a rendering of a real-world scene. The synthetic image can be a rendered image, or generated from a simulation or a generative model, for example. Examples of real images and synthetic images are described below with reference to FIG. 3.

In some examples, the target light source in the second state has a lower intensity than the target light source in the first state. For example, the target light source in the second state can be “off” while the target light source in the first state can be “on.”

For each training example, the system generates multiple respective modified images 122a-n. Each respective modified image depicts the corresponding scene when the target light source is in a respective modified state.

For example, each modified image can depict the corresponding scene according to a respective intensity of ambient light, a respective target intensity of the target light source, and respective change coefficients representing a color change for the target light source.

In some examples, the modified state can be a different state than the first state, the second state, or both. For example, the modified state can have a target intensity (e.g., 50% brightness) that is in between the intensity of the first state and the second state. In some examples, for at least one of the properties, the target light source in the modified state is different from the target light source in the first state, the second state, or both.

In some examples, for at least one of the properties, the target light source in the modified state is the same as the target light source in the first state, the second state, or both. For example, the modified state can have the same target light intensity as the second state. In examples where the target light source in the first state or the second state is fully on or fully off, the system can generate a modified image that depicts the target light source as fully on or fully off. The system can thus generate modified images that are more common in the real world.

As another example, the target light source in the modified state is the same as the target light source in the first state, the second state, or both, and the ambient light of the image can differ from the ambient light in the first image, the second image, or both.

In some examples, the modified state for each of the multiple respective modified images is different from each other modified state. For example, the system can generate modified images where the light intensity differs in increments (e.g., 0.0, 0.25, 0.50, 1.00, etc.) or where different combinations of ambient and target intensities are sampled to cover a wide dynamic range.

The system can generate each modified image using an image modification engine 110. The image modification engine 110 is configured to generate a modified image based on a change in radiant energy between the first image 104 and the second image 106. An example of generating the modified image is described below in further detail with reference to FIG. 3.

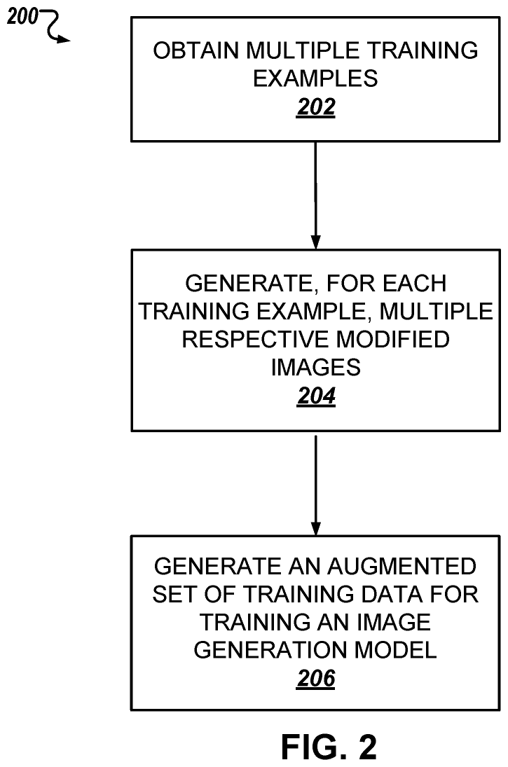

In some examples, the system can update each modified image using a tone mapping engine 120. The tone mapping engine 120 is configured to tone map a modified image to a format optimized for display on a display, e.g., standard dynamic range format. Tone mapping a modified image is described below in further detail with reference to FIGS. 2-3.

In the example of FIG. 1, the system 100 includes two of the modified images 122a-n in the additional training example 130. The system 100 can include the additional training example 130 in the augmented set of training data.

The system 100 can thus generate an augmented set of training data that includes a larger number and variety of training examples than the initial set of training data.

In some implementations, the system 100 can train the image generation model 150 on the augmented set of training data. For example, the system 100 can provide the augmented set of training data to a training system within the system 100 or another training system to train the image generation model 150. For example, the training system can process training examples of the augmented set of training data using the image generation model 150 to determine updates to the parameters of the image processing model 150.

For example, for each training example in the augmented set of training data, the system can assign one image to be a training input and one image to be a ground truth output. The system can train the image generation model 150 by a machine learning technique to reduce a discrepancy between (i) a training output generated by the image processing model 150 for the training input, and (ii) a target output for the training input.

In some examples, the system can generate the training output for the training input by processing at least the training input using the image processing model 150. The target output can include the ground truth output.

In some examples where the image processing model 150 has a diffusion model architecture, the system can train a denoising neural network of the diffusion model. The denoising neural network can have been trained to, at any given time step, process at least the intermediate representation for the output image as of the time step to generate a network output for the time step. For example, the system can execute the denoising neural network to generate a training output for a training input. For example, the system can obtain a noisy representation, e.g., in pixel space or latent space, to serve as the latent representation to be updated at a sampled time step. For example, the system can add noise to the ground truth output or a latent representation for the ground truth output, where the amount of noise corresponds to the sampled denoising iteration. The system can generate the training output by processing a combined input derived from at least the noisy representation and the training input. The training output can include a network output generated by the denoising neural network for the sampled time step. The target output can be, for example, the amount of noise added to the ground truth output, or data representing the ground truth output.

In some examples, the system can generate the training output for the training input by further processing a conditioning training input specifying the lighting modification that was performed on the training input to obtain the ground truth output. For example, the system can obtain the conditioning training input specifying the lighting modification based on data representing properties of the target light source or the properties of the ambient light for the images of the training example. As a particular example, the data representing properties can include the combination of values for intensity of ambient light, target intensity of the target light source, or color change coefficients, used to generate one or more of the images in the training example. The system can generate the combined input further based on the conditioning training input specifying the lighting modification.

As a particular example, the system can train the image generation model 150 using a machine learning training technique, e.g., a gradient descent with backpropagation training technique that uses a suitable optimizer, e.g., stochastic gradient descent, RMSprop, Adam optimizer, or Adafactor optimizer, to optimize an objective function that measures an error (e.g., a reconstruction error) between (i) the training output, and (ii) a target output for the training input.

In some implementations, the image generation model 150 can have been pre-trained, e.g., on a training dataset of training examples that does not include training inputs and ground truth outputs depicting the same scene in different lighting. As an example, the image generation model 150 can have been pre-trained on a training dataset that includes text-image pairs. In these implementations, the system can further train, e.g., fine-tune, the image generation model 150 using the augmented set of training data.

After the image generation model 150 has been trained by the training system on the augmented set of training data, the system 100 or another inference system can use the image generation model 150 to perform image generation tasks. After having been trained on the augmented set of training data, the image generation model 150 can perform better than an image generation model that is trained only on the initial set of training data.

FIG. 2 is a flow diagram of an example process 200 for generating an augmented set of training data. For convenience, the process 200 will be described as being performed by a system of one or more computers located in one or more locations. For example, a system for generating an augmented set of training data, e.g., the system 100 of FIG. 1, appropriately programmed in accordance with this specification, can perform the process 200.

The system obtains multiple training examples (step 202). Each training example includes a respective first image depicting a corresponding scene when a target light source is in a first state. Each training example includes a respective second image depicting the corresponding scene when the target light source is in a second state.

The system generates, for each training example, multiple respective modified images (step 204). Each respective modified image for a training example depicts the corresponding scene when the target light source is in a respective modified state.

In some examples, each respective modified image depicts the corresponding scene when the target light source is in a respective modified state and has one or more respective ambient light properties, e.g., intensity of ambient light. For example, each modified image can depict the corresponding scene when the target light source is in a respective modified state and when the ambient light of the corresponding scene has a respective intensity. In some examples, each respective modified image can depict the corresponding scene with a different combination of respective modified state and ambient light properties.

In some examples, the multiple respective modified images can include an image that is the same as the first image, an image that is the same as the second image, or both. In some examples, the modified state is the same as the first state or the second state. For example, the target light source in the modified state can have the same intensity and color for the target light source as in the first state or in the second state. In some examples, the respective modified state is the same as the first state or the second state, and the respective ambient light properties are the same as ambient light properties for the first image or the second image.

In some examples, the respective first image, the respective second image, or both, are in a raw image format, e.g., includes raw sensor data. The system can transform the respective first image, the respective second image, or both, to a linear color space. For example, the system can transform the respective first image and the respective second image into a calibrated linear red, green, blue (RGB) format.

For example, the system can transform the respective first image in a raw image format based on at least a first exposure value for the respective first image, a first analog gain value for the respective first image, and a first digital gain value for the respective first image. For example, the system can transform the first image according to iₒₙ=Demosaic(rₒₙ*(Eₒₙ*Gₒₙ*Dₒₙ)), where iₒₙ is the transformed first image, rₒₙ is the first image, Eₒₙ is the exposure value for the first image, Gₒₙ is the applied analog gain for the first image, Dₒₙ is the applied digital gain for the first image, and Demosaic( ) is the applied demosaicing algorithm.

The system can transform the respective second image in a raw image format based on at least a second exposure value for the respective second image, a second analog gain value for the respective second image, and a second digital gain value for the respective second image. The system can transform the second image according to i_{off}=Demosaic(r_{off}*(E_{off}*G_{off}*D_{off})), where i_{off} is the transformed second image, r_{off} is the second image, E_{off} is the exposure value for the second image, G_{off} is the applied analog gain for the second image, D_{off} is the applied digital gain for the second image, and Demosaic( ) is the applied demosaicing algorithm.

In some examples, as part of transforming a raw image, the system can calibrate a transformed image. For example, the system can linearly interpolate white balance gains according to the target light source intensity. As another example, the system can apply a color correction matrix to a transformed first image and a transformed second image. In some examples, the system can extract the color correction matrix from the raw image where the light source is switched on.

The system can generate the multiple respective modified images for each training example by determining a change in radiant energy. In some examples, the system can determine the change in radiant energy between the respective first image and the respective second image, e.g., in linear color space. In some other examples, the system can determine the change in radiant energy as the respective first image. Generating the multiple respective modified images is described in more detail below with reference to FIG. 3.

In some examples, the system can update each modified image by tone mapping the modified image, e.g., to a standard dynamic range (SDR) format

In some examples, the system can tone map each respective modified image based on two or more of the multiple respective modified images. For example, the system can tone map the modified image using a sequence of modified images. For example, the sequence of modified images can include two or more of the respective modified images for different combinations of deciding intensities for the target light source and ambient light. An example of tone mapping is described in further detail below with reference to FIG. 3.

The system generates an augmented set of training data for training an image generation model (step 206). The augmented set of training data includes multiple additional training examples. Each additional training example corresponds to one of the training examples. Each additional training example can include two images selected from the respective modified images generated for the corresponding training example.

In some examples, the two images can be two different respective modified images generated for the corresponding training example. For example, each additional training example can include a first image of the two images as a training input, and a second image of the two images as a target output.

In some examples, each training example can include two images sampled from: the respective modified images generated for the corresponding training example, the respective first image of the training example, and the respective second image of the training example. As an example, an additional training example can include the respective first image of the training example as a training input, and a respective modified image generated for the training example as a target output. As another example, an additional training example can include the respective second image of the training example as a training input, and a respective modified image generated for the training example as a target output.

In some examples, each additional training example can include one or more of: a segmentation mask for the target light source, a depth map of the respective first image, a depth map of the respective second image, or a depth map of at least one of the two selected images of the additional training example.

In some examples, each additional training example can include data representing properties of the target light source or the properties of the ambient light for the images of the training example. For example, the data representing the properties of the target light source can include an intensity value for the target light source in each image, or a relative intensity change for the target light source between the images.

In some examples, the data representing the properties of the ambient light can include an intensity value for the ambient light in each image, or a relative ambient light intensity change.

In some examples, the augmented set of training data can include additional training examples for generative removal or generative insertion tasks. For generative removal, the training input can include an image depicting a physical object represented by pixels in the image, and the target output can include a modified image where both the physical object pixels and its counterfactual effects, e.g., cast shadows, illumination, and specular reflections, etc., have been removed and replaced with contextually accurate background textures. For generative insertion, the training input can include an image depicting a scene without a particular light source, and the target output can include a modified image where a new light source has been added to the scene along with lighting effects that are consistent with the scene geometry.

In some implementations, the augmented set of training data also includes the multiple training examples. That is, the augmented set of training data includes the obtained training examples and the generated additional training examples.

FIG. 3 is a diagram of example processes 300 and 350 for generating modified images 340 and 360. For convenience, the processes 300 and 350 will be described as being performed by a system of one or more computers located in one or more locations. For example, a system for generating an augmented set of training data, e.g., the system 100 of FIG. 1, appropriately programmed in accordance with this specification, can perform the processes 300 and 350.

The system can perform the process 300, the process 350, or both, as part of step 204 of the process 200 described above with reference to FIG. 2, to generate modified images for a training example.

In the example of FIG. 3, the system can perform the process 300 in examples where the respective first image 302 and the respective second image 306 of the obtained training example are real images. The system can perform the process 350 in examples where the respective first image 332 and the respective second image 334 of the obtained training example are synthetic images.

The system can generate the multiple respective modified images for each training example by determining a change in radiant energy.

As part of the process 300, the system can determine a change in radiant energy 306 between the respective first image 302 and the respective second image 304.

In some examples, the respective first image 302 and the respective second image 304 are in a linear color space. The respective first image 302 and the respective second image 304 each include multiple pixels, where each pixel includes one or more respective intensity values. For example, the system can determine the change in radiant energy i_{change} 306 by determining a respective difference between each of the one or more respective intensity values of each corresponding pixel for the respective first image iₒₙ 302 and the respective second image i_{off} 304. For example, the system can determine the change in radiant energy in linear image space i_{change} 306 by performing the subtraction iₒₙ−i_{off}.

In some examples, the system can update the change in radiant energy to limit the change in radiant energy to fall within a threshold range. For example, the system can clip the difference to be nonnegative and bounded by a threshold maximum change in radiant energy Eₘₐₓ. The system can limit the change in radiant energy to remove high-intensity noise and outliers.

In some examples, the system can determine the threshold maximum change in radiant energy based on pixel values from a set of random images. For example, the threshold maximum change in radiant energy can be the top 5×10⁻⁴ percentile of pixel values of the set of random images.

Alternatively or in addition, the system can update the change in radiant energy based on at least a first exposure value for the respective first image, a second exposure value for the respective second image, a first analog gain value for the respective first image, a second analog gain value for the respective second image, a first digital gain value for the respective first image, and a second digital gain value for the respective second image.

For example, the system can un-calibrate the change in radiant energy i_{change} to the interpolated Tone Encoding Transform (TET) value Pᵣₑₗᵢₜ. For example, the system can scale i_{change} by the TET value. As an example, the system can determine the TET value Pᵣₑₗᵢₜ according to

$$P \text{?} = ( ( 1 - γ ) \text{?} + \text{?} ) ( ( 1 - γ ) \text{?} + \text{?} ) ( ( 1 - γ ) \text{?} + \text{?} ) , \qquad ( 1 )$$

$$\text{?} \text{indicates text missing or illegible when filed}$$

where α is the respective intensity of ambient light, γ is the respective target intensity of the target light source, Eₒₙ is the first exposure value for the respective first image, E_{off} is the second exposure value for the respective second image, Gₒₙ is the first analog gain value for the respective first image, G_{off} is the second analog gain value for the respective second image, Dₒₙ is the first digital gain value for the respective first image, and D_{off} is the second digital gain value for the respective second image.

In some implementations, the respective first image and the respective second image are in a raw image format. In some examples, the system can transform the respective first image and the respective second image to linear color space, as described above with reference to FIG. 2. The system can determine the change in radiant energy as the difference between the respective first image and the respective second image in linear color space. In some other examples, the system can determine the change in radiant energy as the difference between the respective first image and the respective second image in raw format. The system can transform the change in radiant energy in raw format to a change in radiant energy in linear color space following a similar process as transforming an image to linear color space.

As part of performing the process 300, the system can generate a modified image a 310. For example, the system can compute a first product of the respective second image and the respective intensity of ambient light. The system can compute a second product of the respective target intensity for the target light source, the change in radiant energy, and the respective color change coefficient. The system can generate the modified image iᵣₑₗᵢₜ 310 by computing a sum of the first product and the second product.

For example, the system can generate the modified image iᵣₑₗᵢₜ according to iᵣₑₗᵢₜ(α,γ,cₜ; i_{amb},i_{change})=αi_{amb}+γi_{change}c, where α is the respective intensity of ambient light, γ is the respective target intensity of the target light source, c are change coefficients representing a respective color change for the target light source, i_{amb} is the second image in linear color space, and i_{change} is the change in radiant energy in linear color space.

For example, the system can sample the values for the respective intensity of ambient light α and respective target intensity of the target light source γ from a set of predetermined values. As an example, the system can sample the values from a perceptually uniform gamma curve to ensure the steps in brightness are visually consistent. As another example, the system can sample values for the change coefficients c from a blackbody temperature chart or a perceptually uniform color space. In some examples, the system can prioritize sampling, e.g., sample with a higher probability, endpoint intensities (e.g., values representing a light being fully “on” or fully “off”). The system can thus generate representative modified images, as binary states are often more distinct and common in real-world scenarios.

The system generates multiple modified images 310. In some examples, the system can generate each modified image 310 using a different combination of values for the respective intensity of ambient light α, the respective target intensity of the target light source γ, and the respective change coefficients c representing a color change for the target light source.

In some examples, the system can generate multiple modified images using the same value for the respective intensity of ambient light α, the respective target intensity of the target light source γ, the respective change coefficients c representing a color change for the target light source, or any two of the three values. For example, the system can hold one or two parameters constant while varying the third, allowing for the image generation model to learn independent control over specific lighting properties without affecting others.

Thus, the system can generate a large number of modified images by varying all three parameters or in specific combinations. The system can thus provide a variety of training data for training an image generation model, allowing the image generation model to generalize better at inference.

As an example, the system can generate a modified image where the ambient light is dimmed (α<1.0), the target light is brightened (γ>1.0), and the color is shifted to a warm temperature simultaneously. Training an image generation model on such training data allows the image generation model to learn entangled effects like how a red light source interacts with a dark room versus a bright room.

In some implementations, the system can update the modified image based on at least a first exposure value for the respective first image, a second exposure value for the respective second image, a first analog gain value for the respective first image, a second analog gain value for the respective second image, a first digital gain value for the respective first image, and a second digital gain value for the respective second image.

For example, the system can un-calibrate the modified image iᵣₑₗᵢₜ to the interpolated Tone Encoding Transform (TET) value Pᵣₑₗᵢₜ. For example, the system can scale iᵣₑₗᵢₜ by the TET value. As an example, the system can determine the TET value Pᵣₑₗᵢₜ according to

$$P \text{?} = ( ( 1 - γ ) \text{?} + \text{?} ) ( ( 1 - γ ) \text{?} + \text{?} ) ( ( 1 - γ ) \text{?} + \text{?} ) , \qquad ( 1 )$$

$$\text{?} \text{indicates text missing or illegible when filed}$$

where α is the respective intensity of ambient light, γ is the respective target intensity of the target light source, Eₒₙ is the first exposure value for the respective first image, E_{off} is the second exposure value for the respective second image, Gₒₙ is the first analog gain value for the respective first image, G_{off} is the second analog gain value for the respective second image, Dₒₙ is the first digital gain value for the respective first image, and D_{off} is the second digital gain value for the respective second image.

In some examples, the system can update each modified image by tone mapping the modified image, e.g., to a standard dynamic range (SDR) format sᵣₑₗᵢₜ 320. For example, rather than auto-exposing each modified image individually, which may result in a brightened light source that looks dim, the system can calculate a single exposure value based on multiple modified images to apply to each of the multiple modified images.

For example, the system can tone map each respective modified image based on two or more of the multiple respective modified images. For example, the system can tone map the modified image using a sequence of modified images. For example, the sequence of modified images can include two or more of the respective modified images for different combinations of intensities for the target light source and ambient light.

The system can select deciding intensities for the target light source and ambient light, respectively, e.g., from a predefined set or range of values. The system can generate a reference relit image using the selected deciding intensities as iᵣₑₗᵢₜ (α_{d}, γ_{d}, cₜ; i_{amb}, i_{change}). The system can process the reference relit image to determine a synthetic exposure value. Examples of determining a synthetic exposure value are described in further detail in Hasinoff, S., et al., Burst photography for high dynamic range and low-light imaging on mobile cameras, ACM Trans. Graph., 498 35(6), 2016. The system can apply the synthetic exposure value to each of the modified images in the sequence. The system can thus ensure that relative brightness differences between images in the sequence are preserved, making the lighting changes appear physically plausible and consistent.

In examples where the respective first image 332 and the respective second image 334 of the obtained training example are synthetic images in linear color space, the system can perform the process 350. As part of the process 350, the system can determine a change in radiant energy 336 as the respective first image 332. That is, the system can determine the change in radiant energy 336 to be the respective first image 332.

As part of performing the process 350, the system can generate a modified image iᵣₑₗᵢₜ 340. For example, the system can compute a first product of the respective second image and the respective intensity of ambient light. The system can compute a second product of the respective target intensity for the target light source, the change in radiant energy, and the respective color change coefficient. The system can generate the modified image iᵣₑₗᵢₜ 340 by computing a sum of the first product and the second product.

The system can generate a modified image iᵣₑₗᵢₜ 340 according to iᵣₑₗᵢₜ(α, γ, cₜ; i_{amb}, i_{change})=αi_{amb}+γi_{change}c, where α is the respective intensity of ambient light, is the respective target intensity of the target light source, i_{amb} are respective change coefficients representing a color change for the target light source, is the respective second image, and i_{change} is the change in radiant energy. The system generates multiple modified images 310. In some examples, as described above, the system generates each modified image using a different combination of values for the respective intensity of ambient light α, the respective target intensity of the target light source γ, and the respective change coefficients c representing a color change for the target light source. In some examples, the system can generate multiple modified images using the same value for the respective intensity of ambient light α, the respective target intensity of the target light source γ, the respective change coefficients c representing a color change for the target light source, or any two of the three values.

In some examples, the system can update each modified image by tone mapping the modified image, e.g., to a standard dynamic range (SDR) format sᵣₑₗᵢₜ 350. Tone mapping modified images is described in more detail above.

In some examples, the system can generate modified images for a target light source not represented by pixels of the synthetic first image or the synthetic second image. For example, one of the synthetic images (e.g., the first synthetic image) depicts the scene including the illumination effects of a virtual point light at a designated spatial location, while the other synthetic image (e.g., the second synthetic image) depicts the scene without the illumination effects of that virtual point light. The system can thus apply light arithmetic to the synthetic first image and the synthetic second image as described above to generate multiple modified images representing the virtual point light at a range of different intensities, colors, or both.

In some examples, the system can generate modified images for generative insertion, generative removal, or both. For example, the system can generate training examples where a light source is added or removed between the images of the training example.

For example, for generative insertion, the synthetic second image can include pixels depicting a light source, while the synthetic first image does not include pixels depicting the light source. For generative removal, the synthetic first image can include pixels depicting a light source, while the synthetic second image does not include pixels depicting the light source. The system can thus apply light arithmetic to the synthetic first image and the synthetic second image as described above to generate multiple modified images representing the light source at a range of different intensities, colors, or both.

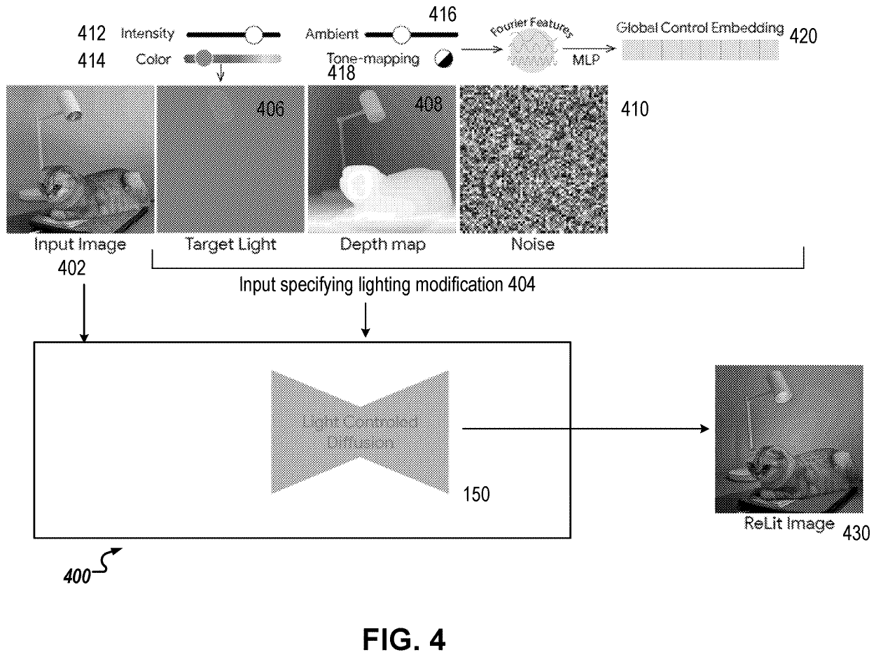

FIG. 4 shows an example system 400 for generating an image using an image generation model 150. The system 400 is an example of a system implemented as computer programs on one or more computers in one or more locations in which the systems, components, and techniques described below are implemented.

The system 400 generates an output image 430 using the image generation model 150. The output image 430 depicts the same scene as an input image 402 according to a lighting modification specified by an input 404.

To generate the output image 412, the system obtains the input image 402. The input image 402 depicts a scene. The input image 402 can be any appropriate image depicting a scene, for example, a real image, a photorealistic image, a non-photorealistic image, e.g., a drawing, a synthetic image, an image generated using the image generation model 150 or another image generation model, etc.

The system obtains the input 404. The input 404 specifies a lighting modification to be performed on the input image 402.

In the example of FIG. 4, the input 404 includes a segmentation mask 406 for a target light source depicted in the input image 402, a depth map 408 for the input image 402, data specifying a relative intensity change 412 for the target light source, data specifying a light color 414 for the target light source, data specifying a relative ambient light intensity change 416, data specifying a tone mapping strategy 418, and a noise input 410.

The system processes at least the input 404 and the input image 402 using the image generation model 150 to generate the output image 412.

For example, the system can update the segmentation mask 406 using the data specifying the relative intensity change 412 and the data specifying a light color 414. The system can process the data specifying the relative ambient light intensity change 416 and the data specifying a tone mapping strategy 418 to generate a set of contextual embeddings 420.

The system can, at each of multiple time steps, process an intermediate representation of the output image 430 for the time step derived from the input image 402 and the input specifying the lighting modification 404 with cross-attention on the set of contextual embeddings 420 to generate an updated intermediate representation of the output image 430 for the time step.

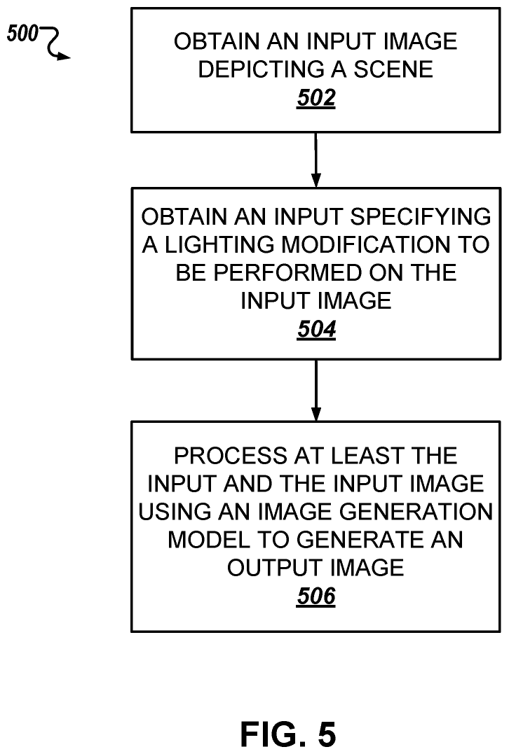

Examples of processing the input 404 and the input image 402 are described in further detail with reference to FIG. 5.

The lighting modification can include, for example, one or more of a relative intensity change for each of one or more target light sources depicted in the input image, a light color change for each of one or more target light sources depicted in the input image, or a relative intensity change for an ambient light of the scene. In some examples, the lighting modification can include inserting a new light source into the input image. In some examples, the lighting modification can include illuminating a non light source depicted in the input image. In some examples, the lighting modification can include removing a light source depicted in the input image. Some examples of lighting modifications are described below with reference to FIGS. 5-6.

As described above with reference to FIG. 1, the image generation model 150 can have any appropriate architecture for generating images with lighting modifications. As a particular example, the image generation model can include a diffusion model.

The image generation model 150 is trained as described above with reference to FIGS. 1-3 to generate images with lighting modifications. For example, the image generation model 150 can have been trained on a training dataset that includes multiple training examples. One or more of the training examples can include at least a first image depicting a corresponding training scene in a first state and a corresponding second image depicting the corresponding training scene in a second state. The first image, the corresponding second image, or both, can have been generated as described above with reference to FIGS. 1-3.

In some implementations, the system can obtain the input image 402, the input 404, or both, from a user. Users can interact with the system, e.g., by providing inputs to the system by way of an interface, e.g., a graphical user interface, or an application programming interface (API).

In some implementations, the system 400 is part of the system 100 described above with reference to FIG. 1. That is, the same system can train and perform inference using the image generation model 150. In some other implementations, the system 400 is separate from the system 100 described above with reference to FIG. 1.

The system can thus generate images with lighting modifications that are specified by the input 404.

FIG. 5 is a flow diagram of an example process 500 for generating an image using an image generation model. For convenience, the process 500 will be described as being performed by a system of one or more computers located in one or more locations. For example, a system for generating an image, e.g., the system 400 of FIG. 4, appropriately programmed in accordance with this specification, can perform the process 500.

The system obtains an input image depicting a scene (step 502).

The system obtains an input specifying a lighting modification to be performed on the input image (step 504).

For example, the lighting modification can include, for each of one or more target light sources depicted in the input image, e.g., as a physical object represented by pixels of the first input image, or as a spatial location within the scene depicted by the input image, a change to one or more properties of the target light source.

For example, the input can include a segmentation mask for one or more target light sources depicted in the input image. The segmentation mask indicates the target light source(s) being modified, e.g., by specifying the locations of pixels in the input image corresponding to the target light source(s). In some examples, the target light source can be represented by pixels in the input image. In some examples, each of the one or more target light sources can be a new light source, e.g., that is not represented by pixels in the input image. In some examples, each of the one or more target light sources can be a non-light source, e.g., an object that conventionally does not emit light in the real world.

In some implementations, the system can obtain the segmentation mask by processing the input image using a segmentation model. In some examples, the system can obtain the segmentation mask by processing the input image and a bounding box, e.g., provided by a user, using the segmentation model.

In some other implementations, each of the one or more target light sources can be a new light source, e.g., depicted at a spatial location in the image. In some of these examples, the segmentation mask can indicate the spatial location, e.g., the point in the image and a circle of a particular radius surrounding the point in the image. In some examples, the system can generate the segmentation mask based on the data representing the spatial location and the radius. For example, the system can obtain data representing the spatial location, e.g., coordinates, and a radius, e.g., a number of pixels, from a user.

The segmentation mask can have the particular spatial dimensions that the image generation model is configured to process. In some examples, the system can resize a segmentation mask obtained using the segmentation model to have the particular spatial dimensions.

As another example, the input can include a depth map for the input image. The depth map indicates the 3D geometry of the scene. In some examples, the system can obtain the depth map by processing the image using monocular depth estimation methods.

The depth map can have the particular spatial dimensions that the image generation model is configured to process. In some examples, the system can resize the depth map obtained using monocular depth estimation methods to have the particular spatial dimensions.

As another example, the input can include data specifying a relative intensity change for each of the one or more target light sources. The relative intensity change indicates how bright or dim the target light source should be compared to the first image. The relative intensity change is a scalar value representing the relative shift in intensity. In some examples, the relative intensity change is sampled from a perceptually uniform gamma curve. As particular examples, the relative intensity change can have a value in the range [−1,1] (where negative values dim the light and positive values brighten the light) or can be represented as relative scalars. In some examples, the system can obtain data specifying the relative intensity change from a user, e.g., through a slider user interface element that allows the user to select a value for the relative intensity change from a range of values.

As another example, the input can include data specifying a light color for each of the one or more target light sources depicted in the input image. The data specifying the light color can include target coefficients, e.g., in RGB format. In some examples, the RGB target coefficients can be sampled from a blackbody temperature chart, e.g., for realistic colors, or a perceptually uniform color space, e.g., for arbitrary colors. In some examples, the system can obtain a light color from a user, e.g., through a slider user interface element that allows the user to select a light color from a range of colors. In some of these examples, the system can generate the target coefficients based on the selected light color.

As another example, the input can include data specifying a relative ambient light intensity change. The relative ambient light intensity change indicates the brightness of the background or environment independent of the target light source. The relative ambient light intensity change is a scalar value representing the relative strength of ambient illumination. In some examples, the system can obtain data specifying the relative ambient light intensity change from a user, e.g., through a slider user interface element that allows the user to select a value for the relative ambient light intensity change from a range of values.

As another example, the input can include data specifying a tone mapping strategy. The tone mapping strategy indicates the strategy for handling the exposure of the generated image. Example strategies can include tone mapping the generated image individually, ensuring that the generated image is well-exposed, or tone mapping generated images across a sequence based on a deciding intensity, which preserves relative brightness changes. The tone mapping strategy can include a scalar value, e.g., a binary value, that indicates the selected strategy.

The system processes at least the input and the input image using an image generation model to generate an output image (step 506). The output image depicts the scene according to the lighting modification specified by the input.

For example, the system can generate a combined representation based on the input image and the input. For example, the system can generate a combined representation based on the input image and one or more of: the segmentation mask for the one or more target light sources depicted in the input image, the depth map, the data specifying the relative intensity change for each of the one or more target light sources, or the data specifying the light color for each of the one or more target light sources.

In some examples where the input includes the relative intensity change for each of the one or more target light sources, or the light color for each of the one or more target light sources, or both, the system can update the segmentation mask. The system can generate the combined representation based on at least the input image and the updated segmentation mask.

For example, the system can update the segmentation mask with the relative intensity change for each of the one or more target light sources. For example, the system can scale, e.g., multiply, the segmentation mask by the relative intensity change for each of the one or more target light sources.

As another example, the system can update the segmentation mask with the light color for each of the one or more target light sources. For example, the system can generate one or more channels for the segmentation mask, each corresponding to a color channel of data representing the color change c. The data representing the color change c can include a set of color change coefficients. As a particular example, the system can generate three channels for RGB color change coefficients. The system can scale, e.g., multiply, each channel for the segmentation mask by the corresponding color channel of the color change coefficients.

In some examples, the system can generate a respective updated segmentation mask for each of the light color and the relative intensity change. For example, the system can generate the combined representation based on at least the input image and the updated segmentation masks.

In some examples, the system can derive the set of color change coefficients based on the target coefficients cₜ for each of the one or more target light sources. For example, the system can determine an estimate of the target light source RGB coefficients cₒ as depicted in the first image. For example, the system can sample from pixels of the first image corresponding to the target light source to determine the estimate. The system can determine the inverse of the estimated coefficients, e.g., by determining the element-wise inverse 1/cₒ. The system can multiply the inverse cₒ⁻¹ by the target coefficients cₜ to determine the data representing the color change c.

In some examples, the system can generate the combined representation by combining, e.g., concatenating, data representing the input image and one or more of the segmentation masks or depth map. The combined representation has the same spatial dimension that the image generation model is configured to process.

In some examples, the data representing the input image can include the input image. In some other examples, the data representing the input image can include a latent representation for the input image. For example, the system can process the input image using an image encoder neural network, e.g., that is part of an image autoencoder, to generate the latent representation for the input image.

In some examples, the system can generate the combined representation by processing one or more of: data representing the input image, the segmentation mask, or the depth map, using one or more convolution layers to generate a respective intermediate representation. As an example, the system can process a concatenation of data representing the input image and the segmentation mask, the depth mask, or both, using the one or more convolution layers to generate the respective intermediate representation. The respective intermediate representation can have the spatial dimensions that the image generation model is configured to process. The system can generate the combined representation based on the respective intermediate representation, e.g., by using the respective intermediate representation as the combined representation.

In some examples, the system can generate the combined representation further based on a noise input. The noise input has the same spatial dimensions that the image generation model is configured to process. In some examples, the system can generate the noise input by sampling from a noise distribution, e.g., a Gaussian distribution or another predetermined distribution.

In some examples, the system can concatenate the noise input with the data representing the input image and one or more of the segmentation mask or the depth mask. The system can process the concatenation of the noise input, the data representing the input image, and one or more of the segmentation mask or the depth mask, e.g., using one or more convolution layers, to generate an intermediate representation. The system can use the intermediate representation as the combined representation.

As a particular example, the system can generate a tensor with spatial dimensions and multiple channels derived from the input and the input image. The combined representation can include, for example, the data representing the input image (4 channels), the depth map (1 channel), the scaled intensity change segmentation mask (1 channel), and the target color segmentation mask (3 channels). The system can combine the tensor with the noise input via a convolution layer to generate a combined representation that matches the channel dimension of the image generation model.

In some other examples, the system can process the concatenation of the data representing the input image, and one or more of the segmentation mask or the depth mask, e.g., using one or more convolution layers, to generate an intermediate representation. The system can combine, e.g., concatenate, the intermediate representation and the noise input to generate the combined representation.

As an example, the lighting modification can include modifying the lighting of an existing light source depicted in the image, e.g., represented by pixels in the input image. In these examples, the input can include a segmentation mask for the existing light source. The system can process at least the latent representation for the input image and the segmentation mask using one or more convolution layers to generate the combined representation.

As an example, the lighting modification can include inserting a new light source into the input image. In these examples, the segmentation mask can include a circular mask for the new light source. For example, the system can obtain data representing the new light source. The data representing the new light source can specify a spatial location, e.g., a center point, for the new light source, and a radius for the new light source. The system can generate a segmentation mask, e.g., a circular mask, based on the location and the radius for the new light source. The system can combine, e.g., concatenate, the segmentation mask and a latent representation for the input image to generate the combined representation.

As another example, the lighting modification can include illuminating a non light source depicted in the input image. In these examples, the input can include a segmentation mask for an object depicted in the input image. The system can process at least the latent representation for the input image and the segmentation mask using one or more convolution layers to generate the combined representation.

In some examples where the input includes data specifying the relative ambient light intensity change, data specifying the tone mapping strategy, or both, the system can generate a set of contextual embeddings for the relative ambient light intensity change, data specifying the tone mapping strategy, or both.

For example, the system can process the data specifying the relative ambient light intensity change, data specifying the tone mapping strategy, or both, to generate a set of features. For example, the system can encode the data specifying the relative ambient light intensity change into Fourier features. As another example, the system can encode the data specifying the tone mapping strategy into Fourier features. The system can include the Fourier features in the set of features.

The system can process the set of features to generate a set of feature embeddings. For example, the system can generate each feature embedding, e.g., by processing the set of features using a Multi-Layer Perceptron (MLP). The system can include the set of feature embeddings in the set of contextual embeddings.

In some examples, the system can generate each feature embedding to be in a particular embedding dimension. In some examples, the image generation model can include a text encoder configured to generate an output of the particular embedding dimension. That is, the particular embedding dimension can be the text embedding dimension of the text encoder.

In some implementations, to generate the output image, the system can, at each of multiple time steps, process an intermediate representation of the output image for the time step with cross-attention on the set of contextual embeddings to generate an updated intermediate representation of the output image for the time step.

For example, the system can initialize the intermediate representation of the output image at the first time step to be the combined representation. The system can update the intermediate representation of the output image by denoising the intermediate representation using a denoising neural network of the diffusion model with the denoising neural network conditioned on the set of contextual embeddings.

At each time step, the system processes at least the current version of the intermediate representation for the output image using the denoising neural network to generate a network output for the time step. The network output defines an estimate of a target output given the current version, e.g., is an estimate of the noise added to the target output to generate the current version or is the estimate of the target output given the current version. The target output can include a denoised version of the intermediate representation.

For example, at each time step, the system can process the intermediate representation for the output image as of the denoising iteration and the set of contextual embeddings using the denoising neural network to update the intermediate representation. For example, the diffusion model can process the intermediate representation for the output image as of the denoising iteration and the set of contextual embeddings using cross-attention layers to generate an attended representation. The diffusion model can process the attended representation using the denoising neural network to generate the network output at the time step.

The system can use the network output at the time step to update the intermediate representation for the output image in any appropriate manner. For example, the system can use any appropriate diffusion model state transition rule, e.g., DDIM (further details of which can be found in J. Song et al., Denoising Diffusion Implicit Models, ICLR 2021, which is hereby incorporated by reference in its entirety), DDPM (further details of which can be found in J. Ho et al., Denoising Diffusion Probabilistic Models, NeurIPS, 2020, which is hereby incorporated by reference in its entirety), or another appropriate state transition rule.

As another example, the system can use the network output at the time step to update the intermediate representation for the output image by performing flow matching. For example, the system can use the network output to define a velocity field that describes a continuous probability path from a noise distribution to a data distribution. The system can update the intermediate representation by integrating the velocity field to move the latent representation along the continuous probability path. Further details are described in Lipman et al., Flow Matching for Generative Modeling, arXiv preprint:2210.02747 (2023).

As another example, the system can use the network output at the time step to update the intermediate representation for the output image using multi-step consistency. For example, the system can use the network output to predict a consistent state (e.g., a latent representation for a final clean image) along a probability flow trajectory extending from a noise distribution to a data distribution. The system can update the intermediate representation by mapping the intermediate representation towards the predicted consistent state. Further details are described in Song et al., Consistency Models, arXiv preprint:2303.01469 (2023).

As another example, the system can use the network output at the time step to update the intermediate representation for the output image using a high-order differential equation solver. As another example, the system can use the network output at the denoising iteration to update the intermediate representation for the output image using a numerical ODE solver, such as an Euler solver or a Heun solver.

In some implementations, the system can perform a guided denoising process. In some examples, the guidance can be classifier-free guidance. For example, the system can generate, using the denoising neural network, at any given time step, multiple network outputs. The system can generate a first network output for the time step by processing the intermediate representation and the set of contextual embeddings. The system can generate a second network output for the time step by processing the intermediate representation for the output image, independently of the set of contextual embeddings. Alternatively or additionally, the system can generate one or more additional network outputs for the denoising iteration, where each additional network output is generated by processing a representation derived from a noise input and the input image independently of a respective portion of the input (i.e., by masking or omitting a specific subset of the input from the combined representation, the set of contextual embeddings, or both). The system can combine the multiple network outputs (e.g., the first network output and the second network output, or the first network output and one or more additional network outputs), e.g., according to a weighted sum, to generate a combined network output. The system can use the combined network output to update the intermediate representation.

In some examples, the system can create animations or perform sequential light editing using a static image. For example, the system can process at least the image to generate a modified image with a lighting modification (e.g., turning off ambient light entering through a window). The system can process the modified image to generate a further modified image with another lighting modification (e.g., subsequently turning off an interior light source, turning on a different light source, changing a light's color, or utilizing a relative intensity scale that allows for iterative refinement). Additionally, the system can generate stop-motion type animations by processing a sequence of images where a light source (e.g., a lamp) that is turned off is physically moved to different positions. For each frame, the system can generate a modified image that turns the light on, correctly interpreting the scene geometry to generate plausible shadows, reflections, and lighting corresponding to the new position of the light source.

FIG. 6 shows example images generated by image generation models such as the image generation model 150 described above. FIG. 6 shows that the system described in this specification can be used to generate images with lighting modifications that are precise and parametric.

For example, the images 600 and 601 are examples of turning a light source on or off. As another example, the images 602 are an example of changing the color, e.g., temperature or RGB value, of the target light source. As another example, the images 604 are an example adjusting the brightness of the target light source. As another example, the images 606 are an example of inserting virtual light sources, each denoted by “x”, into the scene. As another example, the images 608 are an example of adjusting the intensity of the scene's ambient light.

As another example, the images 610 are an example of sequential editing. For example, each image demonstrates disentangled light changes, where modifying one source, e.g., turning off a light source, turning on a different light source, changing a color of a light source, etc., results in consistent and physically plausible shadows and reflections.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In addition to the embodiments described above, the following embodiments are also innovative:

Embodiment 1. A computer-implemented method comprising:
obtaining a plurality of training examples, each training example comprising a respective first image depicting a corresponding scene when a target light source is in a first state and a respective second image depicting the corresponding scene when the target light source is in a second state;
generating, for each training example, a plurality of respective modified images that each depict the corresponding scene when the target light source is in a respective modified state; and
generating an augmented set of training data for training an image generation model, wherein the augmented set of training data comprises a plurality of additional training examples, each additional training example corresponding to one of the training examples and comprising two images selected from the plurality of respective modified images generated for the corresponding training example.
   Embodiment 2. The method of embodiment 1, wherein for each training example, the respective first image and the respective second image are in a raw image format.
   Embodiment 3. The method of embodiment 2, wherein generating, for each training example, a plurality of respective modified images comprises transforming the respective first image to a linear color space.
   Embodiment 4. The method of embodiment 3, wherein transforming the respective first image to a linear color space comprises transforming the respective first image based on at least a first exposure value for the respective first image, a first analog gain value for the respective first image, and a first digital gain value for the respective first image.
   Embodiment 5. The method of any of embodiments 1-4, wherein generating, for each training example, a plurality of respective modified images comprises transforming the respective second image to a linear color space.
   Embodiment 6. The method of embodiment 5, wherein transforming the respective second image to a linear color space comprises transforming the respective second image based on at least a second exposure value for the respective second image, a second analog gain value for the respective second image, and a second digital gain value for the respective second image.
   Embodiment 7. The method of any of embodiments 1-6, wherein generating, for each training example, a plurality of respective modified images comprises, for each training example, determining a change in radiant energy between the respective first image and the respective second image.
   Embodiment 8. The method of embodiment 7, wherein the respective first image and the respective second image are in a linear color space, and wherein the respective first image and the respective second image each comprise a respective plurality of pixels, each comprising one or more respective intensity values.
   Embodiment 9. The method of embodiment 8, wherein determining a change in radiant energy between the respective first image and the respective second image comprises determining a respective difference between each of the one or more respective intensity values of each corresponding pixel for the respective first image and the respective second image.
   Embodiment 10. The method of any of embodiments 7-9, wherein determining the change in radiant energy comprises limiting the change in radiant energy to fall within a threshold range.
   Embodiment 11. The method of any of embodiments 7-10, wherein determining the change in radiant energy comprises updating the change in radiant energy based on at least a first exposure value for the respective first image, a second exposure value for the respective second image, a first analog gain value for the respective first image, a second analog gain value for the respective second image, a first digital gain value for the respective first image, and a second digital gain value for the respective second image.
   Embodiment 12. The method of any of embodiments 1-6, wherein generating, for each training example, a plurality of respective modified images comprises, for each training example, determining a change in radiant energy as the respective first image.
   Embodiment 13. The method of any of embodiments 8-12, wherein generating, for each training example, a plurality of respective modified images comprises:
for each of the plurality of respective modified images, generating the respective modified image based on at least the change in radiant energy.
   Embodiment 14. The method of embodiment 13, wherein generating the respective modified image comprises generating the respective modified image based on one or more of: a respective target intensity for the target light source, a respective intensity of ambient light, or a respective color change coefficient representing a color change for the target light source.
   Embodiment 15. The method of embodiment 14, wherein generating the respective modified image comprises:
computing a first product of the respective second image and the respective intensity of ambient light;
computing a second product of the respective target intensity for the target light source, the change in radiant energy, and the respective color change coefficient; and
computing a sum of the first product and the second product.
   Embodiment 16. The method of any preceding embodiment, wherein generating, for each training example, a plurality of respective modified images comprises:
for each of the plurality of respective modified images, tone mapping the respective modified image to a standard dynamic range format.
   Embodiment 17. The method of embodiment 16, wherein tone mapping the respective modified image to a standard dynamic range format comprises tone mapping the respective modified image based on two or more of the plurality of respective modified images.
   Embodiment 18. The method of any preceding embodiment, wherein each additional training example further comprises one or more of: a segmentation mask for the target light source, a depth map of the respective first image, a depth map of the respective second image, or a depth map of at least one of the two selected images of the additional training example.
   Embodiment 19. The method of any preceding embodiment, wherein for one or more of the plurality of training examples, the respective first image and the respective second image comprise synthetic images.
   Embodiment 20. The method of any preceding embodiment, further comprising training the image generation model on the augmented set of training data.
   Embodiment 21. The method of any preceding embodiment, wherein the image generation model comprises a diffusion model.
   Embodiment 22. The method of any preceding embodiment, wherein the augmented set of training data further comprises the plurality of training examples.
   Embodiment 23. The method of any preceding embodiment, wherein the target light source is depicted in the first image and in the second image.
   Embodiment 24. A method performed by one or more computers, the method comprising:
obtaining an input image depicting a scene;
obtaining an input specifying a lighting modification to be performed on the input image; and
processing at least the input and the input image using an image generation model to generate an output image that depicts the scene according to the lighting modification specified by the input.
   Embodiment 25. The method of embodiment 24, wherein the input comprises one or more of: a segmentation mask for one or more target light sources depicted in the input image, a depth map for the input image, data specifying a relative intensity change for each of the one or more target light sources, data specifying a light color for each of the one or more target light sources depicted in the input image, data specifying a relative ambient light intensity change, or data specifying a tone mapping strategy.
   Embodiment 26. The method of any of embodiments 24-25, wherein processing at least the input and the input image comprises:
generating a combined representation based on the input image and one or more of: the segmentation mask for the one or more target light sources depicted in the input image, the depth map, the data specifying the relative intensity change for each of the one or more target light sources, or the data specifying the light color for each of the one or more target light sources.
   Embodiment 27. The method of embodiment 26, wherein generating the combined representation comprises:
updating the segmentation mask with one or more of: the relative intensity change for each of the one or more target light sources, or the light color for each of the one or more target light sources; and
generating the combined representation based on at least the input image and the updated segmentation mask.
   Embodiment 28. The method of any one of embodiments 26-27, wherein generating the combined representation comprises:
processing one or more of: the input image, the segmentation mask, or the depth map using one or more convolution layers to generate a respective intermediate representation; and
generating the combined representation based on the respective intermediate representations.
   Embodiment 29. The method of any of embodiments 26-28, wherein generating the combined representation further comprises generating the combined representation based on a noise input.
   Embodiment 30. The method of any of embodiments 24-29, wherein processing at least the input and the input image comprises processing one or more of: the data specifying the relative ambient light intensity change, or the data specifying the tone mapping strategy, to generate a set of contextual embeddings.
   Embodiment 31. The method of embodiment 30, wherein generating a set of contextual embeddings comprises:
processing one or more of: the data specifying the relative ambient light intensity change, or the data specifying the tone mapping strategy, to generate a set of features;
processing the set of features to generate a set of feature embeddings; and
including the set of feature embeddings in the set of contextual embeddings.
   Embodiment 32. The method of embodiment 31, wherein the image generation model comprises a text encoder configured to generate an output of an embedding dimension, and wherein generating a set of feature embeddings comprises generating each feature embedding to be in the embedding dimension.
   Embodiment 33. The method of embodiment 32, wherein generating a set of contextual embeddings comprises:
processing a sequence of text using the text encoder to generate a set of text embeddings; and
including the set of text embeddings in the set of contextual embeddings.
   Embodiment 34. The method of any of embodiments 30-32, wherein generating the output image comprises, at each of multiple time steps:
processing an intermediate representation of the output image for the time step with cross-attention on the set of contextual embeddings to generate an updated intermediate representation of the output image for the time step.
   Embodiment 35. The method of any of embodiments 24-34, wherein the input image comprises a real image, a synthetic image, or a drawing.
   Embodiment 36. The method of any of embodiments 24-35, wherein the lighting modification comprises one or more of: a relative intensity change for each of one or more target light sources depicted in the input image, a light color change for each of one or more target light sources depicted in the input image, or a relative intensity change for an ambient light of the scene.
   Embodiment 37. The method of any of embodiments 24-36, wherein the image generation model comprises a diffusion model.
   Embodiment 38. The method of any of embodiments 24-37, wherein the image generation model has been trained on a training dataset comprising a plurality of training examples, wherein one or more of the training examples each comprise at least a first image depicting a corresponding training scene in a first state and a corresponding second image depicting the corresponding training scene in a second state.
   Embodiment 39. The method of any one of embodiments 24-38, wherein the lighting modification comprises, for each of one or more target light sources depicted in the input image, a change in one or more properties of the target light source.
   40. A system comprising:
one or more computers; and one or more storage devices storing instructions that, when executed by the one or more computers, cause the one or more computers to perform operations of the respective method of any one of embodiments 1-39.
   41. One or more computer-readable storage media storing instructions that when executed by one or more computers cause the one more computers to perform operations of the respective method of any of embodiments 1-39.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method comprising:
obtaining a plurality of training examples, each training example comprising a respective first image depicting a corresponding scene when a target light source is in a first state and a respective second image depicting the corresponding scene when the target light source is in a second state;
generating, for each training example, a plurality of respective modified images that each depict the corresponding scene when the target light source is in a respective modified state; and
generating an augmented set of training data for training an image generation model, wherein the augmented set of training data comprises a plurality of additional training examples, each additional training example corresponding to one of the training examples and comprising two images selected from the plurality of respective modified images generated for the corresponding training example.

2. The method of claim 1, wherein for each training example, the respective first image and the respective second image are in a raw image format, and wherein generating, for each training example, a plurality of respective modified images comprises transforming the respective first image and the respective second image to a linear color space.

3. The method of claim 1, wherein generating, for each training example, a plurality of respective modified images comprises, for each training example, determining a change in radiant energy between the respective first image and the respective second image.

4. The method of claim 3, wherein the respective first image and the respective second image are in a linear color space, and wherein the respective first image and the respective second image each comprise a respective plurality of pixels, each comprising one or more respective intensity values.

5. The method of claim 4, wherein determining a change in radiant energy between the respective first image and the respective second image comprises determining a respective difference between each of the one or more respective intensity values of each corresponding pixel for the respective first image and the respective second image.

6. The method of claim 3, wherein determining the change in radiant energy comprises limiting the change in radiant energy to fall within a threshold range.

7. The method of claim 1, wherein generating, for each training example, a plurality of respective modified images comprises, for each training example, determining a change in radiant energy as the respective first image.

8. The method of claim 4, wherein generating, for each training example, a plurality of respective modified images comprises:
for each of the plurality of respective modified images, generating the respective modified image based on at least the change in radiant energy.

9. The method of claim 8, wherein generating the respective modified image comprises generating the respective modified image based on one or more of: a respective target intensity for the target light source, a respective intensity of ambient light, or a respective color change coefficient representing a color change for the target light source.

10. The method of claim 9, wherein generating the respective modified image comprises:
computing a first product of the respective second image and the respective intensity of ambient light;
computing a second product of the respective target intensity for the target light source, the change in radiant energy, and the respective color change coefficient; and
computing a sum of the first product and the second product.

11. The method of claim 1, wherein generating, for each training example, a plurality of respective modified images comprises:
for each of the plurality of respective modified images, tone mapping the respective modified image to a standard dynamic range format.

12. The method of claim 11, wherein tone mapping the respective modified image to a standard dynamic range format comprises tone mapping the respective modified image based on two or more of the plurality of respective modified images.

13. The method of claim 1, wherein each additional training example further comprises one or more of: a segmentation mask for the target light source, a depth map of the respective first image, a depth map of the respective second image, or a depth map of at least one of the two selected images of the additional training example.

14. A method performed by one or more computers, the method comprising:
obtaining an input image depicting a scene;
obtaining an input specifying a lighting modification to be performed on the input image; and
processing at least the input and the input image using an image generation model to generate an output image that depicts the scene according to the lighting modification specified by the input.

15. The method of claim 14, wherein the input comprises one or more of: a segmentation mask for one or more target light sources depicted in the input image, a depth map for the input image, data specifying a relative intensity change for each of the one or more target light sources, data specifying a light color for each of the one or more target light sources depicted in the input image, data specifying a relative ambient light intensity change, or data specifying a tone mapping strategy.

16. The method of claim 15, wherein processing at least the input and the input image comprises:
generating a combined representation based on the input image and one or more of: the segmentation mask for the one or more target light sources depicted in the input image, the depth map, the data specifying the relative intensity change for each of the one or more target light sources, or the data specifying the light color for each of the one or more target light sources.

17. The method of claim 15, wherein processing at least the input and the input image comprises processing one or more of: the data specifying the relative ambient light intensity change, or the data specifying the tone mapping strategy, to generate a set of contextual embeddings.

18. The method of claim 17, wherein generating the output image comprises, at each of multiple time steps:
processing an intermediate representation of the output image for the time step with cross-attention on the set of contextual embeddings to generate an updated intermediate representation of the output image for the time step.

19. The method of claim 14, wherein the lighting modification comprises one or more of: a relative intensity change for each of one or more target light sources depicted in the input image, a light color change for each of one or more target light sources depicted in the input image, or a relative intensity change for an ambient light of the scene.

20. A system comprising:
one or more computers; and
one or more storage devices storing instructions that, when executed by the one or more computers, cause the one or more computers to perform operations comprising:
obtaining a plurality of training examples, each training example comprising a respective first image depicting a corresponding scene when a target light source is in a first state and a respective second image depicting the corresponding scene when the target light source is in a second state;
generating, for each training example, a plurality of respective modified images that each depict the corresponding scene when the target light source is in a respective modified state; and
generating an augmented set of training data for training an image generation model, wherein the augmented set of training data comprises a plurality of additional training examples, each additional training example corresponding to one of the training examples and comprising two images selected from the plurality of respective modified images generated for the corresponding training example.
